(19) United States
(12) Patent Application Publication
(10) Pub. No.: US 2015/0369963 A1
(43) Pub. Date: Dec. 24, 2015

(54) ACRYLIC COPOLYMER, OPTICAL FILM, POLARIZING PLATE AND LIQUID CRYSTAL DISPLAY DEVICE

(71) Applicants: KEIO UNIVERSITY, Tokyo (JP); JX NIPPON OIL & ENERGY CORPORATION, Tokyo (JP)

(72) Inventors: Yasuhiro KOIKE, Kanagawa-ken (JP); Akihiko TAGAYA, Kanagawa-ken (JP); Sayako UCHIZAWA, Tokyo-to (JP); Akira MATSUO, Tokyo-to (JP); Yasuo MATSUMURA, Tokyo-to (JP)

(21) Appl. No.: 14/646,894

(22) PCT Filed: Nov. 22, 2013
(86) PCT No.: PCT/JP2013/081487

§ 371 Date: Sep. 8, 2015

(30) Foreign Application Priority Data
Nov. 22, 2012 (JP) 2012-256764

(51) Int. Cl. G02B 1/08; C08J 5/18; G02B 5/30; C08F 220/10

(52) U.S. Cl. CPC G02B 1/08; C08F 220/10; C08J 5/18; G02B 5/3083; C08J 2333/12

(57) ABSTRACT

There are provided an optical film having both low orientation birefringence and low photoelastic birefringence and, at the same time, having excellent transparency and heat resistance, and a polarizing plate including the optical film and a liquid crystal display device. An acrylic copolymer according to the present invention includes as constituent units 0.5 to 35% by mass of N-aromatic substituted maleimide units and 60 to 85% by mass of alkyl (meth)acrylate units having a negative intrinsic birefringence in terms of a homopolymer.

### TECHNICAL FIELD

The present invention relates to an acrylic copolymer and more specifically relates to an acrylic copolymer that can be formed into films having both low orientation birefringence and low photoelastic birefringence and, at the same time, having excellent transparency, heat resistance, and flexibility, and an optical film including the acrylic copolymer, a polarizing film and a liquid crystal display device.

### BACKGROUND ART

Various film-shaped optical members used in various optics-related devices (for example, films used in liquid crystal display devices and substrates of prism sheets) are generally called “optical films.” Birefringence is one of important optical properties in the optical films. That is, large birefringence is sometimes unfavorable for optical films. In particular, in liquid crystal display devices in IPS mode, the presence of a film having large birefringence adversely affects image quality, and, thus, the use of an optical film having minimized birefringence has been desired, for example, in protective films for polarizing plates used in liquid crystal display devices.

For example, Japanese Patent Application Laid-Open No. 242754/2011 discloses optical films having a small phase difference as optical films for use in protective films for polarizing plates, the optical films including a (meth)acrylic copolymer including N-substituted maleimide units and (meth)acrylic ester units as constituent units.

### PRIOR ART DOCUMENTS

### Patent Documents

Patent document 1: Japanese Patent Application Laid-Open No. 242754/2011

### SUMMARY OF THE INVENTION

### Problems to be Solved by the Invention

An “orientation birefringence” mainly derived from the orientation of the main chain of the polymer and a “photoelastic birefringence” derived from stress applied to the film may be mentioned as the birefringence exhibited by the optical film.

The orientation birefringence is generally a birefringence developed by the orientation of the main chain of a polymer having a chain-like structure, and the orientation of the main chain occurs, for example, in a process involving flow of the material such as a process of extrusion or stretching in film production and is fixed and remains in the film.

On the other hand, the photoelastic birefringence is a birefringence caused by elastic deformation of the film. For example, volume shrinkage that occurs upon cooling from a temperature around the glass transition temperature of the polymer to a temperature below the transition temperature causes elastic stress to stay within the film, which is causative of the photoelatstic birefringence. Further, external force which the optical film receives in such a state that the optical film is fixed to a device at an ordinary temperature also leads to the occurrence of stress in the film that in turn leads to the development of photoelastic birefringence.

What is desired for optical films applied to polarizing plates, particularly polarizing plates for IPS, is that, in addition to good transparency and heat resistance, both the orientation birefringence and the photoelastic birefringence are satisfactorily low.

Japanese Patent Application Laid-Open No. 242754/2011 discloses optical films having a small phase difference, that is, a small orientation birefringence, but is silent on a photoelastic birefringence, and, in this patent application laid-open document, optical films that simultaneously have good transparency, heat resistance, orientation birefringence, and photoelastic birefringence are not realized.

Accordingly, an object of the present invention is to provide an acrylic copolymer that can be formed into films having both low orientation birefringence and low photoelastic birefringence and, at the same time, having excellent transparency, heat resistance, and flexibility. Another object of the present invention is to provide an optical film including the acrylic copolymer, and a polarizing plate including the optical film and a liquid crystal display device.

### Means for Solving the Problems

According to the present invention, there is provided an acrylic copolymer comprising as constituent units 0.5 to 35% by mass of N-aromatic substituted maleimide units and 60 to 85% by mass of alkyl (meth)acrylate units having a negative intrinsic birefringence in terms of a homopolymer.

The present invention can realize an acrylic copolymer that can be formed into films having both low orientation birefringence and low photoelastic birefringence and, at the same time, having excellent transparency, heat resistance, and flexibility. Accordingly, the optical film including the acrylic copolymer according to the present invention is suitable as optical films for use in optics-related devices, particularly protective films for polarizing plates.

In the present invention, preferably, the acrylic copolymer further comprises third constituent units selected from the group consisting of N-alkyl substituted maleimide units and (meth)acrylic ester units having a positive intrinsic birefringence in terms of a homopolymer.

In the present invention, preferably, the acrylic copolymer comprises 1 to 24% by mass of the third constituent units.

In the present invention, the N-aromatic substituted maleimide units may include N-phenylmaleimide units, and the alkyl (meth)acrylate units may comprise ethyl methacrylate units.

In the present invention, the third constituent units may comprise at least one type of units selected from the group consisting of N-cyclohexylmaleimide units, phenoxyethyl acrylate units, phenoxyethyl methacrylate units, benzyl methacrylate units, 2,4,6-tribromophenyl acrylate units, and 2,2,2-trifluoroethyl methacrylate units.

In the present invention, preferably, the acrylic copolymer has a weight mean molecular weight of 0.5×10⁵ to 3.0×10⁵.

In the present invention, preferably, the acrylic copolymer has a glass transition temperature of 120° C. or above.

In the present invention, preferably, the acrylic copolymer has a melt flow rate of not less than 1.0 g/10 min.

In the present invention, preferably, the content of the residual monomer in the acrylic copolymer is not more than 3% by mass.

In the present invention, preferably, the 1% weight reduction pyrolysis temperature of the acrylic copolymer is 285° C. or above.

In another aspect of the present invention, there is provided an optical film produced by subjecting an unstretched film of a resin material containing the acrylic copolymer to biaxially stretching.

In the present invention, preferably, both the absolute value of the in-plane phase difference, Re, and the absolute value of the phase difference in the thicknesswise direction, Rth, of the optical film are not more than 10 nm.

In the present invention, preferably, the absolute value of the photoelastic coefficient C of the optical film is not more than 3.0×10⁻¹²/Pa.

In the present invention, preferably, the optical film has a MIT folding endurance frequency of not less than 150 times as measured according to JIS (Japanese Industrial Standards) P 8115.

According to further aspect of the present invention, there are provided a polarizing plate comprising the optical film and a liquid crystal display device comprising the polarizing plate.

### Effect of the Invention

The present invention can realize an acrylic copolymer that can be formed into films having both low orientation birefringence and low photoelastic birefringence and, at the same time, having excellent transparency, heat resistance, and flexibility. Accordingly, the optical film using the acrylic copolymer according to the present invention has both low orientation birefringence and low photoelastic birefringence and thus can satisfactorily reduce an adverse effect on image quality and is suitable for use as optical films used in optics-related equipment such as liquid crystal display devices, particularly as protective films for polarizing plates.

### MODE FOR CARRYING OUT THE INVENTION

Preferred embodiments of the present invention will be described.

<Acrylic Copolymer>

The acrylic copolymer according to the present invention includes as indispensable constituent units 0.5 to 35% by mass of N-aromatic substituted maleimide units and 60 to 85% by mass of alkyl (meth)acrylate units having a negative intrinsic birefringence in terms of a homopolymer. In the present invention, the (meth)acrylic acid refers to acrylic acid or methacrylic acid. Monomer units constituting the acrylic copolymer according to the present invention will be described.

The N-aromatic substituted maleimide units are constituent units obtained from N-aromatic substituted maleimide monomers. N-Aromatic substituted maleimide units are constituent units including an aromatic group substituted on a nitrogen atom in maleimide units, and the aromatic group may be a monocyclic aromatic group or a polycyclic aromatic group.

The number of carbon atoms of the aromatic group in the N-aromatic substituted maleimide units is preferably 6 to 18, more preferably 6 to 14.

Examples of aromatic groups in the N-aromatic substituted maleimide units include phenyl, naphthyl, anthryl, and phenanthryl groups. Among them, phenyl and naphthyl groups are preferred, and the phenyl group is more preferred.

That is, examples of N-aromatic substituted maleimide units include N-phenylmaleimide units, N-naphthylmaleimide units, N-anthrylmaleimide units, and N-phenanthrylmaleimide units. Among them, N-phenylmaleimide units and N-naphthylmaleimide units are preferred, and N-phenylmaleimide units are more preferred. The acrylic copolymer may contain one or at least two N-aromatic substituted maleimide units.

The content of N-aromatic substituted maleimide units in the acrylic copolymer is not less than 0.5% by mass, preferably not less than 1% by mass, more preferably not less than 3% by mass, still more preferably not less than 5% by mass. When the content of the N-aromatic substituted maleimide units is below the lower limit of the above-defined range, the absolute value of the in-plane phase difference, Re, the absolute value of the phase difference value in the thicknesswise direction, Rth, and the absolute value of the photoelastic coefficient, C, of optical films formed from the copolymer are likely to be increased.

The content of N-aromatic substituted maleimide units in the acrylic copolymer is not more than 35% by mass, preferably not more than 32% by mass, more preferably not more than 29% by mass. When the content of the N-aromatic substituted maleimide units is above the upper limit of the above-defined range, the absolute value of the in-plane phase difference, Re, the absolute value of the phase difference value in the thicknesswise direction, Rth, and the absolute value of the photoelastic coefficient, C, of optical films formed from the copolymer are likely to be increased.

When the acrylic copolymer does not contain third constituent units that will be described below, the content of N-aromatic substituted maleimide units in the acrylic copolymer is preferably 15 to 35% by mass, more preferably 17 to 32% by mass. When the content of the N-aromatic substituted maleimide units is in the above-defined range, optical films having better optical properties are likely to be obtained.

Examples of alkyl (meth)acrylate units that exhibit a negative intrinsic birefringence in terms of a homopolymer include methyl acrylate units, methyl methacrylate units, isobornyl methacrylate units, dicyclopentanyl methacrylate units, ethyl adamantyl methacrylate units, methyl adamantyl methacrylate units, ethyl methacryl units, n-butyl methacrylate units, and cyclohexyl methacrylate units. Among them, methyl acrylate units and methyl methacrylate units are preferred, and methyl methacrylate units are more preferred. The acrylic copolymer may contain one or at least two alkyl (meth)acrylate units.

The content of alkyl (meth)acrylate units in the acrylic copolymer is not less than 60% by mass, preferably not less than 62% by mass, more preferably not less than 65% by mass. When the content of the alkyl (meth)acrylate units is below the lower limit of the above-defined range, in the optical film, the absolute value of the phase difference value in the thicknesswise direction, Rth, and the absolute value of the photoelastic coefficient, C, are likely to be increased. Further, a problem of yellowing is likely to occur.

The content of the alkyl (meth)acrylate units in the acrylic copolymer is not more than 85% by mass, preferably not more than 83% by mass, more preferably not more than 80% by mass. When the content of the alkyl (meth)acrylate units is above the above-defined range, the Tg of the acrylic copolymer is likely to be lowered.

The acrylic copolymer may contain, in addition to the two constituent units, third constituent units selected from the group consisting of N-alkyl substituted maleimide units and (meth)acrylic ester units that exhibit a positive intrinsic birefringence in terms of a homopolymer. When the acrylic copolymer contains the third constituent units, the content of the N-aromatic substituted maleimide units is preferably not less than 0.5% by mass, more preferably not less than 1% by mass, still more preferably not less than 3% by mass, particularly preferably not less than 5% by mass. The content is preferably not more than 25% by mass, more preferably not more than 23% by mass. When the content of the N-aromatic substituted maleimide units is in the above-defined range, optical films having better optical properties are likely to be obtained.

The total content of the N-aromatic substituted maleimide units and the third constituent units in the acrylic copolymer is preferably not less than 10% by mass, more preferably not less than 12% by mass, still more preferably not less than 15% by mass. The total content of the N-aromatic substituted maleimide units and the third constituent units is preferably not more than 40% by mass, more preferably not more than 38% by mass, still more preferably not more than 35% by mass. When the total content of the N-aromatic substituted maleimide units and the third constituent units is in the above-defined range, optical films having better optical properties are likely to be obtained.

The N-alkyl substituted maleimide units are constituent units obtained from the N-alkyl-substituted maleimide monomer. The N-alkyl substituted maleimide units are constituent units including an alkyl group substituted on a nitrogen atom in maleimide units, and the alkyl group may be a chain alkyl or cycloalkyl group, and the cycloalkyl group is preferred. The chain alkyl is an alkyl group free from a ring structure, and the cycloalkyl group is an alkyl group having a ring structure.

The number of carbon atoms of the alkyl group in the N-alkyl substituted maleimide units is preferably 1 to 10, more preferably 3 to 8.

Examples of alkyl groups in the N-alkyl substituted maleimide units include methyl, ethyl, n-propyl, isopropyl, n-butyl, isobutyl, t-butyl, n-hexyl, 2-ethylhexyl, dodecyl, lauryl, and cyclohexyl groups. Among them, methyl, ethyl, and cyclohexyl groups are preferred, and the cyclohexyl group is more preferred.

That is, examples of N-alkylmaleimide units include N-methylmaleimide units, N-ethylmaleimide units, N-n-propylmaleimide units, N-isopropylmaleimide units, N-n-butylmaleimide units, N-isobutylmaleimide units, N-t-butylmaleimide units, N-n-hexylmaleimide units, N-2-ethylhexylmaleimide units, N-dodecylmaleimide units, N-laurylmaleimide units, and N-cyclohexylmaleimide units. Among them, N-methylmaleimide units, N-ethylmaleimide units, and N-cyclohexylmaleimide units are preferred, and N-cyclohexylmaleimide units are more preferred. The N-alkylmaleimide units may include one or at least two of these units.

Examples of (meth)acrylic ester units that exhibit a positive intrinsic birefringence in terms of a homopolymer include aromatic ring-containing (meth)acrylic ester units and fluorine atom-containing (meth)acrylic ester units, and the (meth)acrylic ester units may include one or at least two of these units.

In the aromatic ring-containing (meth)acrylic ester units, examples of aromatic rings include benzene ring, naphthalene ring, and anthracene ring. Among them, the benzene ring is preferred. Examples of benzene ring-containing (meth)acrylic ester units include (meth)phenoxyethyl acrylate units, benzyl (meth)acrylate units, 2,4,6-tribromophenyl (meth)acrylate units, phenoxydiethylene glycol (meth)acrylate units, biphenyl (meth)acrylate units, pentafluorobenzyl (meth)acrylate units, trifluorophenyl (meth)acrylate units. Among them, phenoxyethyl (meth)acrylate units, benzyl (meth)acrylate units, and 2,4,6-tribromophenyl (meth)acrylate units are preferred.

Examples of fluorine atom-containing (meth)acrylic ester units include fluorine-substituted aromatic group-containing (meth)acrylic ester units and alkyl fluoride-containing (meth)acrylic ester units. Alkyl fluoride (meth)acrylate units are preferred as the fluorine atom-containing (meth)acrylic ester units. Examples of alkyl fluoride (meth)acrylate include trifluoromethyl (meth)acrylate units, 2,2,2-trifluoroethyl (meth)acrylate units, 1-(trifluoromethyl)-2,2,2-trifluoroethyl (meth)acrylate units, 2,2,3,3-tetrafluoropropyl (meth)acrylate units, 2,2,3,3,3-pentafluoropropyl (meth)methacrylate units, and 1H,1H,5H-octafluoropentyl (meth)acrylate units. Among them, 2,2,2-trifluoroethyl (meth)acrylate units are preferred.

When the acrylic copolymer contains the third constituent units, the content of the third constituent units may be not less than 1% by mass and may be not less than 2% by mass. Further, the content of the third constituent units in the acrylic copolymer may be not more than 26% by mass and is preferably not more than 24% by mass, more preferably not more than 22% by mass. When the content of the third constituent units is in the above-defined range, optical films having better optical properties are likely to be obtained.

The optimal content of the third constituent units may also vary depending upon the type. For example, when the third constituent units are N-alkyl substituted maleimide units, the content of the third constituent units in the acrylic copolymer is preferably not less than 5% by mass, more preferably not less than 7% by mass, still more preferably not less than 9% by mass, particularly preferably not less than 11% by mass. The content of the N-alkyl substituted maleimide units is preferably not more than 22% by mass, more preferably not more than 20% by mass, still more preferably not more than 17% by mass, particularly preferably not more than 14% by mass. When the content of the third constituent units is in the above-defined range, optical films having better optical properties are likely to be obtained.

When the third constituent units are (meth)acrylic ester units, the content of the third constituent units in the acrylic copolymer is preferably not less than 1% by mass, more preferably not less than 1.5% by mass, still more preferably not less than 2% by mass. The content of the (meth)acrylic ester units is preferably not more than 25% by mass, more preferably not more than 23% by mass, still more preferably not more than 20% by mass. When the content of the third constituent units is in the above-defined range, optical films having better optical properties are likely to be obtained.

The weight average molecular weight (Mw) of the acrylic copolymer according to the present invention is preferably 0.5×10⁵ to 3.0×10⁵, more preferably 0.7×10⁵ to 2.9×10⁵, still more preferably 0.9×10⁵ to 2.7×10⁵, from the viewpoints of flexibility of films formed therefrom and film production efficiency such as melt flow rate (MFR). In the present invention, the range of the weight average molecular weight of the acrylic copolymer is not limited. In general, however, when the weight average molecular weight is above the upper limit of the above-defined range, the viscosity of a melt of the acrylic copolymer is so high that, in some cases, the film production efficiency is disadvantageously lowered. For example, when films are formed through an extruder using the acrylic copolymer, the extruder is equipped with a filter for the removal of foreign materials contained in the resin. When the melt viscosity of the resin is excessively high, an enhanced pressure is applied to the filter, sometimes leading to lowered filter performance and, in some cases, damage to the filter. When the weight average molecular weight is in the above-defined range, a lowering in filter performance in film formation can be suppressed, contributing to an improved production efficiency.

In the present specification, the weight average molecular weight of the acrylic copolymer is a value in terms of standard polystyrene molecular weight measured by HLC-8220 GPC manufactured by Tosoh Corporation. Super-Multipore HZ-M manufactured by Tosoh Corporation is used as a column. The measurement may be carried out under conditions of tetrahydrofuran (THF) for HPLC as the solvent, a flow rate of 0.35 ml/min, and a column temperature of 40° C.

Preferably, the acrylic copolymer according to the present invention has a glass transition temperature Tg of 120° C. or above. When the Tg is in the above-defined range, the heat resistance of the film is further improved, contributing to an improvement in dimensional stability against heat and, thus, the film is more suitable as protective films for polarizing plates. The upper limit of the glass transition temperature Tg is not particularly limited. When the acrylic copolymer is used as optical films, the Tg may be 160° C. or below and may be 150° C. or below from the viewpoint of realizing satisfactory heat resistance of the optical film.

In the present specification, the glass transition temperature is a value determined from an onset temperature of a glass transition point when the temperature is raised at a temperature rise rate of 10° C./min with a differential scanning calorimetric measuring device DSC7020 manufactured by SII Nanotechnology. The weight of a sample is 5 mg to 10 mg.

Preferably, the acrylic copolymer according to the present invention has a melt flow rate (MFR) of not less than 1.0 g/10 min. Since this acrylic copolymer has excellent fluidity, films can easily be formed by melt extrusion, contributing to an improved film production efficiency. The upper limit of the melt flow rate (MFR) is not particularly limited. The melt flow rate (MFR) may be not more than 40 g/10 min and may be not more than 30 g/10 min.

In the present specification, the melt flow rate (MFR) is a value measured with a melt indexer F-F01 (manufactured by Toyo Seiki Co., Ltd.) under conditions of a heavy load of 3.8 kg and 260° C. according to JIS K 7020.

Preferably, the acrylic copolymer according to the present invention has a 1% weight reduction pyrolysis temperature (hereinafter referred to simply as “pyrolysis temperature”) of 285° C. or above. As is described below, the acrylic copolymer according to the present invention is a material suitable as optical films. In general, however, in film formation, the unstretched film is subjected to a high-temperature process (for example, a melt extrusion process). In this case, the decomposition or deterioration of the acrylic copolymer sometimes poses problems of foaming that makes it difficult to obtain smooth films, lowered workability due to the occurrence of unusual odor, or a high susceptibility to coloring of the resultant films. In the present invention, when the 1% weight reduction pyrolysis temperature of the acrylic copolymer is 285° C. or above, decomposition or deterioration of the acrylic copolymer in the high-temperature process in the film formation is satisfactorily suppressed, making it possible to obtain unstretched films that are smooth and have satisfactorily suppressed coloring with good workability. The heat resistance of the film is further improved, and, thus, the film is more suitable as protective films for polarizing plates. The upper limit of the pyrolysis temperature is not particularly limited. From the viewpoint of realizing satisfactory heat resistance as optical films, however, the pyrolysis temperature may be 400° C. or below and may be 350° C. or below.

In the present specification, the pyrolysis temperature is a temperature determined by providing a simultaneous thermogravimetric/differential thermal analyzer TG/DTA7200 manufactured by SIT Nanotechnology, raising the temperature to 180° C. at a rise rate of 10° C./min, holding the temperature for 60 min, raising the temperature to 450° C. at a rise rate of 10° C./min, and determining the temperature at which the mass of the acrylic copolymer was reduced by 1% by weight based on the weight of the acrylic copolymer at 250° C.

<Production Process of Acrylic Copolymer>

The acrylic copolymer according to the present invention can be obtained by copolymerizing the above-described three types of monomer units. Any polymerization method may be used without particular limitation, and examples thereof include bulk polymerization, suspension polymerization, emulsion polymerization, and solution polymerization. Among them, suspension polymerization is suitable from the viewpoints of easy treatment after polymerization and unnecessity of heating and the like for the removal of the organic solvent in the treatment after the polymerization.

In the acrylic copolymer according to the present invention, polymers having an improved hue can be produced by the suspension polymerization. Unlike the solution polymerization, the suspension polymerization does not require the step of removing the organic solvent at an elevated temperature from the polymerization system and, thus, acrylic copolymers having a further improved hue can be obtained.

For example, when a copolymer of methyl methacrylate with N-cyclohexylmaleimide described in Japanese Patent Application Laid-Open No. 242754/2011 is formed into a film, the hue of the film is likely to be lowered. The present inventors have found that the presence of a large amount of residual monomers in the acrylic copolymer after polymerization is causative of a lowered hue. The present inventors have further found that incorporation of the N-aromatic substituted maleimide units, the alkyl (meth)acrylate units that exhibit a negative intrinsic birefringence in terms of a homopolymer, and, if desired, third constituent units in respective specific ratios can contribute to an improved monomer conversion and a satisfactory reduction in the amount of residual monomers in the acrylic copolymer after the polymerization. Even when the amount of residual monomers is large, coloring of the acrylic copolymer per se is not noticeable. According to finding by the present inventors, when the amount of residual monomer is large, yellowing is produced, for example, by heating in the step of forming a film from a resin material containing the acrylic copolymer.

In the present invention, the amount of residual monomers is preferably not more than 5% by mass, more preferably not more than 4% by mass, particularly preferably not more than 3% by mass.

Conditions for suspension polymerization are not particularly limited, and publicly known conditions for suspension polymerization can be properly applied. One embodiment of the production process of acrylic copolymer by suspension polymerization will be described. However, it should be noted that the present invention is not limited to this embodiment.

Monomers (N-aromatic substituted maleimide, alkyl (meth)acrylate, and a monomer for constituting the third constituent units) are weighed at desired mass ratios, and the total amount was brought to 100 parts by mass. Deionized water (300 parts by mass based on 100 parts by mass of the total amount of monomers) and 0.6 part by mass, based on 100 parts by mass of the total amount of monomers, of polyvinyl alcohol (Kuraray Poval manufactured by Kuraray Co., Ltd.) as a dispersant are introduced into a suspension polymerization apparatus, and stirring is started. The weighed monomers, one part by mass of Peroyl TCP manufactured by NOF Corporation as a polymerization initiator, and 0.22 part by mass of 1-octanethiol as a chain transfer agent are introduced into the suspension polymerization apparatus.

Thereafter, while passing nitrogen into the suspension polymerization apparatus, the reaction system is heated to 70° C. and is then held at 70° C. for 3 hr for a reaction. After the reaction, the contents of the reaction system are cooled to room temperature and are if necessary subjected to, for example, filtration, washing, and drying to obtain a particulate acrylic copolymer. According to this method, an acrylic copolymer having a weight average molecular weight of 0.5×10⁵ to 3.0×10⁵ can easily be obtained.

The type and the amount of the polymerization initiator introduced, the chain transfer agent and the dispersant described above are merely an example, and conditions for the suspension polymerization are not limited to the above conditions. In the suspension polymerization, conditions can be properly varied as long as the weight average molecular weight of 0.5×10⁵ to 3.0×10⁵ can be achieved. For example, the weight average molecular weight of the acrylic copolymer can be properly regulated by varying the amount of the chain transfer agent introduced.

Examples of polymerization initiators include Peroyl TCP, Perocta O, and Nyper BW manufactured by NOF CORPORATION. The amount of the polymerization initiator used may be, for example, 0.05 to 2.0 parts by mass and may be 0.1 to 1.5 parts by mass based on 100 parts by mass in total of the monomers.

Examples of chain transfer agents usable herein include thiols such as 1-octanethiol, 1-dodecanthiol, and tert-dodecanthiol. The amount of the chain transfer agent used may be properly varied depending upon the desired weight average molecular weight. For example, the amount of the chain transfer agent may be 0.05 to 0.6 part by mass and may be 0.07 to 0.5 part by mass based on 100 parts by mass in total of the monomers.

For example, PVAs such as Kuraray Poval manufactured by Kuraray Co., Ltd. and sodium polyacrylate may be used as the dispersant. The amount of the dispersant used may be 0.01 to 0.5 part by mass and may be 0.02 to 0.3 part by mass based on 100 parts by mass in total of the monomers.

Conditions for the suspension polymerization may be properly regulated depending, for example, upon the type and usage of the polymerization initiator, the chain transfer agent, and the dispersant. For example, the reaction temperature may be 50 to 90° C., preferably 60 to 85° C. The reaction time may be a period of time that allows the reaction to satisfactorily proceed and may be, for example, 2 to 10 hr, preferably 3 to 8 hr. The monomer conversion is determined, for example, by the service life of reaction active species and the reactivity of monomers, and, thus, the prolongation of the reaction time does not always contribute to an improvement in monomer conversion.

The acrylic copolymer according to the present invention is suitable as resin materials for optical films. The acrylic copolymer according to the present invention can provide optical films that have both low orientation birefringence and low photoelastic birefringence and have excellent transparency, heat resistance, and flexibility.

<Optical Film>

The optical film according to the present invention is a film formed from a resin material containing the acrylic copolymer and is preferably a film formed by subjecting an unstretched film obtained by film formation to biaxially stretching. Mechanical properties such as tensile strength, flex resistance and the like of the optical film can be improved by monoaxial stretching or biaxial stretching of the unstretched optical film. In the present invention, when the acrylic copolymer is used, even stretched optical films can have both low orientation birefringence and low photoelastic birefringence and excellent transparency, heat resistance, and flexibility. Various properties of the optical film according to the present invention will be described in detail.

Both the absolute value of the in-plane phase difference, Re, and the absolute value of the phase difference in the thicknesswise direction, Rth, are preferably not more than 3.0 nm, more preferably not more than 2.5 nm, still more preferably not more than 2.0 nm, particularly preferably not more than 1.0 nm. When the absolute value of the in-plane phase difference, Re, and the absolute value of the phase difference in the thicknesswise direction, Rth, are low, the orientation birefringence is low and, thus, the film is more suitable as optical films, particularly as protective films for polarizing plates.

The absolute value of the photoelastic coefficient C of the optical film is preferably not more than 3.0×10⁻¹² (/Pa), more preferably not more than 2.0×10⁻¹² (/Pa), still more preferably not more than 1.0×10⁻¹² (/Pa), still more preferably not more than 5.0×10⁻¹³ (/Pa) and may be not more than 1.0×10⁻¹³ (/Pa). When the absolute value of the photoelastic coefficient C is low, the photoelastic birefringence is low and, thus, the film is more suitable as optical films, particularly as protective films for polarizing plates.

The orientation birefringence of the optical film can be evaluated by measuring retardation that is an in-plane phase difference value of the film, Re, and a phase difference value in the thicknesswise direction, Rth, with an Axoscan apparatus manufactured by Axometrics.

Re is expressed by equation (1):

Re=(nₓ−n_{y})×d(nm) (1)

wherein nₓ represents the refractive index in one direction of an in-plane of the film; n_{y} represents the refractive index in a direction perpendicular to the in-plane one direction; and d represents the thickness of the film, nm.

Rth is expressed by equation (2):

Rth=((nₓ+n_{y})/2−n_{z})×d(nm) (2)

wherein nₓ represents the refractive index in one direction of an in-plane of the film; n_{y} represents the refractive index in a direction perpendicular to the in-plane one direction; n_{z} represents the refractive index in the thicknesswise direction of the film; and d represents the thickness of the film, nm.

Regarding the sign of the phase difference value of the film, when the refractive index in an orientation direction of the main chain of the polymer is large, a positive sign is adopted, while, when the refractive index in a direction perpendicular to the stretching direction is large, a negative sign is adopted.

The photoelastic birefringence of the optical film is determined as a photoelastic coefficient C [10⁻¹²/Pa] by measuring the level of change in retardation (Re) (a phase difference value) of the film caused by stress applied to the film with an Axoscan apparatus manufactured by Axometrics, as with the orientation birefringence. Specifically, the photoelastic coefficient C is calculated by equation (3).

C=ΔRe/(Δσ×t) (3)

wherein Δσ represents the level of change in stress applied to the film, Pa; t represents the thickness of the film, m; and ΔRe represents the level of change in in-plane phase difference value corresponding to the level of change in stress indicated by Δσ, m. Regarding the sign of the photoelastic coefficient C, when the refractive index in a stress-applied direction is large, a positive sign is adopted, while, when the refractive index in a direction perpendicular to the stress-applied direction is large, a negative sign is adopted.

Preferably, the optical film has an MIT folding endurance frequency of 150 times or more as measured according to JIS P 8115. This optical film satisfactorily satisfies flexibility required as protective films for polarizing plates and thus is more suitable as protective films for polarizing plates. Further, this optical film has excellent flexing resistance and is more suitable for applications where an increase in area is required.

In the present specification, the MIT folding endurance test may be carried out with a BE-201 MIT flex resistance tester manufactured by Tester Sangyo Co., Ltd. that is also called a MIT folding endurance testing machine. The measurement is carried out under conditions of a load of 200 g, a flexing point end R of 0.38, a flexing rate of 175 times/min, a flexing angle of 135° on right and left, and a film sample width of 15 mm. The average of the number of times of flexing that caused breaking in repeated flexing of the optical film in the conveying direction, and the number of times of flexing that caused breaking in repeated flexing in the widthwise direction is regarded as the MIT folding endurance frequency.

When the MIT folding endurance frequency is 150 times or more, breaking of the optical film in the step of conveying and winding the optical film after the step of stretching or breaking, for example, in the step of laminating the optical film to a polarizing plate or the like can be avoided.

A heat shock test that includes laminating the film to a glass substrate through a paste and repeating temperature raising and temperature falling from −20° C. to 60° C. at intervals of 30 min by 500 cycles is known as a testing method for heat shock resistance of a protective film for a polarizing plate. When the MIT folding endurance frequency is 150 times or more, cracking in the film during the heat shock test can be avoided.

The MIT folding endurance frequency of the optical film is preferably 150 times or more, more preferably 160 times or more, still more preferably 170 times or more.

The thickness of the optical film may be 10 μm to 150 μm and may also be 15 μm to 120 μm. When the thickness of the optical film is not less than 10 μm, the handleability of the film is good. When the thickness of the optical film is not more than 150 μm, problems such as a haze increase and an increase in material cost per unit area are less likely to occur.

In this embodiment, the optical film may be a film obtained by stretching an unstretched film of a resin material containing the acrylic copolymer in one direction or is preferably a film obtained by stretching in two directions (a biaxially stretched film). For example, the stretch ratio may be not less than 1.3 times and may be not less than 1.5 times in terms of area ratio. The stretch ratio may be not more than 6.0 times and may be not more than 4.0 times in terms of area ratio.

The b* value that is a measure of yellowness of the optical film is preferably not more than 1.00, more preferably not more than 0.50, still more preferably not more than 0.30. The b* value that is a measure of yellowness of the optical film may be determined by measuring a spectroscopic spectrum of the optical film with Spectrophotometer SD6000 manufactured by NIPPON DENSHOKU INDUSTRIES CO., LTD.

The optical film according to the present invention has excellent lightfastness. The lightfastness can be evaluated by the level of change in film property values between before light irradiation and after light irradiation. For example, b* value that is a measure of yellowness, in-plane phase difference, Re, phase difference in the thicknesswise direction, Rth, photoelastic coefficient, C, and MIT folding endurance frequency are used as film property values. For example, a method may be adopted in which an optical film is irradiated with light emitted from a xenon weatherometer (Atlas Ci4000 manufactured by Toyo Seiki Seisaku-Sho, Ltd.) and the lightfastness is evaluated as follows.

The lightfastness can be evaluated from a value obtained by subtracting b* value after light irradiation from b* value (b*¹) before light irradiation, i.e., Δb* (=b*¹−b*), a value obtained by subtracting an in-plane phase difference Re after light irradiation from a in-plane phase difference Re before light irradiation, i.e., ΔRe (=Re before light irradiation−Re after light irradiation), a value obtained by subtracting a phase difference in the thicknesswise direction, Rth, after light irradiation from a phase difference in the thicknesswise direction, Rth, before light irradiation, i.e., ΔRth (=Rth before light irradiation−Rth after light irradiation), a value obtained by subtracting a photoelastic coefficient C after light irradiation from a photoelastic coefficient C before light irradiation, i.e., ΔC (=C before light irradiation−C after light irradiation), and a value obtained by subtracting a MIT folding endurance frequency after light irradiation from a MIT folding endurance frequency before light irradiation, i.e., ΔMIC (MIT before light irradiation−MIT after light irradiation).

The optical film according to the present invention may contain components other than the acrylic copolymer. Specifically, when the optical film is one obtained by at least stretching an unstretched film of a resin material containing the acrylic copolymer in one direction, the resin material may contain components other than the acrylic copolymer.

Additives used in optical films such as antioxidants, lubricants, ultraviolet absorbers, and stabilizers may if necessary be used as components other than the acrylic copolymer. The amount of these components incorporated is not particularly limited as long as the effect of the present invention is usefully exerted but is preferably not more than 10% by mass, more preferably not more than 5% by mass, based on the total amount of the resin material. Specifically, the content of the acrylic copolymer in the resin material is preferably not less than 90% by mass, more preferably not less than 95% by mass and may be not less than 99% by mass based on the total amount of the resin material.

<Production Process of Optical Film>

One embodiment of the production process of an optical film according to the present invention will be described in detail. In this embodiment, as described above, the optical film can be obtained by stretching an unstretched film of a resin material containing the acrylic copolymer in one direction. Specifically, the production process of an optical film according to the present invention includes a step of melt-extruding a resin material containing an acrylic copolymer to obtain an unstretched film (a melt extrusion step) and a step of subjecting stretching the unstretched film to biaxially stretching to obtain a biaxially stretched film (a stretching step).

The step of melt extrusion can be carried out, for example, by an extrusion film forming machine provided with a die lip. In this case, the resin material is heat-melted within the extrusion film forming machine, and the melt is continuously delivered through the die lip to form a film.

The extrusion temperature in the melt extrusion is preferably 130° C. to 300° C., more preferably 150° C. to 280° C. When the extrusion temperature is 130° C. or above, the acrylic copolymer in the resin material is satisfactorily melt-kneaded. Thus, the stay of an unmelted product in the film can be satisfactorily avoided. When the extrusion temperature is 300° C. or below, the occurrence of problems such as coloring of the film by thermal decomposition or the deposition of decomposition products on the die lip can be satisfactorily avoided.

In a molten film formation method using a T-die extruder, the temperature of the first roll with which the molten resin delivered through the T-die lip is first brought into contact, T₁° C., is preferably (Tg−24)≦T₁≦(Tg+24), more preferably (Tg−20)≦T₁≦(Tg+20), wherein Tg represents a glass transition temperature of the molten resin, ° C. When the temperature of T₁ is (Tg−24)° C. or above, rapid cooling of the molten resin film delivered through the T-die lip can be suppressed and, thus, a lowering in the accuracy of thickness of the formed film caused by uneven shrinkage can be suppressed. When the temperature of T₁ is (Tg+24)° C. or below, sticking of the molten resin delivered through the T-die lip to the first roll can be suppressed.

The unevenness of the film thickness (unit: %) refers to a value determined by cutting off an edge of both ends of an ununstretched film (a web film) by 10 mm to prepare a roll sample, measuring the thickness of the film at 20 points at equal intervals in the direction of the width, and calculating the unevenness of the thickness according to the following equation (4):

Unevenness of thickness (%)=100×(t₁−t₂)/t₃ (4)

where t₁ is the maximum value of the thickness, μm; t₂ is the minimum value of the thickness, μm; and t₃ is the average of the thickness, μm.

In the step of stretching, the unstretched film (web film) obtained in the step of melt extrusion is stretched to obtain an optical film. Conventional monoaxial stretching method and biaxial stretching method may be properly selected for stretching. The biaxially stretching apparatus may be, for example, in a tenter stretching apparatus, a simultaneous biaxially stretching apparatus in which the clip spacing for holding the end of the film is also increased in the conveying direction of the film. In the step of stretching, a successive biaxially stretching method including a combination of stretching between rolls using a circumferential velocity difference and stretching using a tenter device may also be adopted.

The stretching device may constitute a continuous through-line with an extrusion film forming machine. In the step of stretching, a method may also be adopted in which the web film wound by the extrusion film forming machine is delivered offline to the stretching device and stretched.

The stretching temperature is preferably Tg+2° C. to Tg+20° C., more preferably Tg+5° C. to Tg+15° C., wherein Tg represents the glass transition temperature of the web film, ° C. When the stretching temperature is Tg+2° C. or above, the occurrence of problems such as breaking of the film during stretching and an increase in haze of the film can be satisfactorily avoided. When the stretching temperature is Tg+20° C. or below, the main chain of the polymer is likely to be oriented and, consequently, the degree of orientation of the main chain of the polymer is likely to be better.

The stretching of the web film formed by the molten film forming method can contribute to orientation of the main chain of the polymer to improve the flex resistance of the film. However, when the film is not formed of a polymer material having a low birefringence, the film disadvantageously has an increased phase difference value and, thus, when incorporated in a liquid crystal display device, disadvantageously causes a deterioration in image quality. In this embodiment, an optical film that simultaneously has excellent optical properties and flex resistance can be obtained by using the above resin material.

As described above, the production process according to the present invention can provide an optical film that have both low orientation birefringence and low photoelastic birefringence and have excellent transparency, heat resistance, and flexibility.

<Polarizing Plate>

The polarizing plate according to the present invention includes the optical film as a protective film provided on at least one surface of a polarizing film. Since the optical film have both low orientation birefringence and low photoelastic birefringence, the polarizing plate including the optical film as the protective film, when applied to a liquid crystal display device, can satisfactorily suppress a deterioration in image quality by the protective film.

In the polarizing plate according to the present invention, constituent elements other than the optical film are not particularly limited, and the construction of the polarizing plate may be the same as that of publicly known polarizing plates except for the optical film. Specifically, the polarizing plate according to the present invention may have the same construction as a publicly known polarizing plate, except that the above optical film is used instead of at least a part of a protective film. The polarizing plate may include, for example, the optical film, a polarizing layer, a protective film for the polarizing layer, and a pressure-sensitive adhesive layer stacked in that order.

<Liquid Crystal Display Device>

The liquid crystal display device according to the present invention includes the polarizing plate. As described above, since the polarizing plate according to the present invention includes the optical film as a protective film, a deterioration in image quality derived from optical properties of the protective film can be satisfactorily suppressed. Thus, the liquid crystal display device according to the present invention can realize a good image quality.

In the liquid crystal display device according to the present invention, constituent elements other than the polarizing plate are not particularly limited, and the construction of the liquid crystal display device may be the same as that of publicly known liquid crystal display devices except for the polarizing plate. Specifically, the liquid crystal display device according to the present invention may have the same construction as a publicly known liquid crystal display device, except that the above polarizing plate is used instead of polarizing plates in publicly known liquid crystal display device.

The liquid crystal display device may include, for example, the polarizing plate, a backlight, a color filter, a liquid crystal layer, a transparent electrode, and a glass substrate stacked in that order.

Preferred embodiments in the present invention have been described above. However, it should be noted that the present invention is not limited to the above embodiments.

### EXAMPLES

The present invention is further illustrated by the following Examples that are not intended as a limitation of the invention.

<Method for Evaluation of Synthesis of Acrylic Copolymer>

For acrylic copolymers, the weight average molecular weight Mw, the glass transition temperature (Tg), the amount of the residual monomer, the melt flow rate (MFR), and the 1% mass reduction temperature were measured by the following methods.

The weight average molecular weight Mw is a value in terms of standard polystyrene molecular weight as measured with HLC-8220 GPC manufactured by Tosoh Corporation. Super-Multipore HZ-M manufactured by Tosoh Corporation was used as a column. The measurement was carried out under conditions of use of tetrahydrofuran (THF) for HPLC as a solvent, a flow rate of 0.35 ml/min, and a column temperature of 40° C.

The glass transition temperature Tg was determined from an onset temperature of a glass transition point when the temperature was raised at a temperature rise rate of 10° C./min with a differential scanning calorimetric measuring device DSC7020 manufactured by SIT Nanotechnology. The mass of samples of acrylic copolymers was 5 mg to 10 mg.

The amount of the residual monomer in the acrylic copolymer was measured by the following apparatus and method.

(Apparatus)
Gas chromatography: GC 6850 manufactured by Agilent Technologies Japan, Ltd.
Column: HP-5 30 m
Conditions for oven temperatures: The temperature of the sample was held at 50° C. for 5 min, was then raised to 250° C. at a rate of 10° C./min, and was held at that temperature for 10 min
Injection amount: 0.5
Mode: Splitting method
Split ratio: 80/1
Carrier: Pure nitrogen
Detector: FID

(Method)

One g of particles of the acrylic copolymer was accurately weighed, about 10 ml of acetone was added to the acrylic copolymer, and the mixture was stirred to fully dissolve the particles and thus to prepare an acetone solution. About 90 ml of methanol was measured into a 100-ml vessel containing a stirrer, the acetone solution was added dropwise to the methanol to precipitate the polymer and thus to prepare a slurry solution. Subsequently, about 0.1 ml of chlorobenzene was accurately measured as an internal standard substance and was added to the slurry solution, and the mixture was vigorously shaken for mixing. The resultant solution was allowed to stand, and 1.5 ml of the supernatant was filtered, followed by the detection of individual monomers by GC (gas chromatography). For each component, the retention time and the area/mass conversion factor were as described in Table 1 below.

TABLE 1

| | Retention | Area/mass |
|---|---|---|
| Name | time (min) | conversion factor |
| Methyl methacrylate | 3.93 | 1.41 |
| Chlorobenzene | 7.19 | 1.00 |
| (internal standard substance) | | |
| N-Phenylmaleimide | 19.79 | 1.31 |
| N-Cyclohexylmaleimide | 18.58 | 1.41 |
| Phenoxyethyl acrylate | 19.20 | 1.16 |
| Phenoxyethyl methacrylate | 20.30 | 1.11 |
| 2,2,2-Trifluoroethyl methacrylate | 3.65 | 2.49 |
| 2,4,6-Tribromophenyl acrylate | 24.01 | 3.34 |
| Benzyl methacrylate | 17.23 | 0.96 |
| Dicyclopentanyl methacrylate | 22.49 | 0.97 |

GC area for each monomer was multiplied by area/mass conversion factor, and the mass of each monomer was calculated by the following proportional equation.

Mass of internal standard substance:mass of each monomer=(GC area of internal standard substance×area/mass conversion factor):(GC area of each monomer×area/mass conversion factor)

The amount of residual monomer (%) was calculated by determining the mass of each of the residual monomers in the accurately weighed acrylic copolymer particles by the above method and dividing the sum by the mass of the accurately weighed acrylic copolymer particles.

The melt flow rate was measured with a melt indexer F-F01 manufactured by Toyo Seiki Co., Ltd.

The 1% mass reduction temperature was determined by providing a simultaneous thermogravimetric/differential thermal analyzer TG/DTA7200 manufactured by SII Nanotechnology, raising the temperature to 180° C. at a rise rate of 10° C./min, holding the temperature for 60 min, raising the temperature to 450° C. at a rise rate of 10° C./min, and determining the temperature at which the mass of the acrylic copolymer was reduced by 1% by mass based on the mass of the acrylic copolymer at 250° C.

<Synthesis of Acrylic Copolymer>

Acrylic copolymers (a-1) to (a-9) and (b-1) to (b-7) were synthesized as follows, and the weight average molecular weight Mw, the glass transition temperature Tg, the melt flow rate MFR, the amount of residual monomer, and 1% mass reduction temperature were measured for the acrylic copolymers thus obtained.

(Synthesis of Acrylic Copolymer (a-1))

Deionized water (300 parts by mass) and 0.6 part by mass of polyvinyl alcohol (Kuraray Poval manufactured by Kuraray Co., Ltd.) as a dispersant together were introduced into a reaction kettle provided with a stirring apparatus, a temperature sensor, a cooling pipe, and a nitrogen introduction pipe, and stirring was started. Methyl methacrylate (hereinafter sometimes referred to as “MMA”) (78 parts by mass), 22 parts by mass of N-phenylmaleimide (hereinafter sometimes referred to as “PhMI”), 1 part by mass of Peroyl TCP manufactured by NOF Corporation as a polymerization initiator, and 0.22 part by mass of 1-octanethiol as a chain transfer agent were charged into the reaction kettle, and the temperature was raised to 70° C. while passing nitrogen into the reaction kettle. The contents of the kettle were held at the temperature 70° C. for 3 hr, cooled, filtered, washed, and dried to obtain a particulate acrylic copolymer (a-1).

(Synthesis of Acrylic Copolymer (a-2))

An acrylic copolymer (a-2) was obtained by the synthesis of an acrylic copolymer in the same manner as described in the synthesis of the acrylic copolymer (a-1), except that 80 parts by mass of methyl methacrylate (MMA) and 20 parts by mass of N-phenylmaleimide (PhMI) were used as monomers.

(Synthesis of Acrylic Copolymer (a-3))

An acrylic copolymer (a-3) was obtained by the synthesis of an acrylic copolymer in the same manner as described in the synthesis of the acrylic copolymer (a-1), except that 83 parts by mass of methyl methacrylate (MMA) and 17 parts by mass of N-phenylmaleimide (PhMI) were used as monomers.

(Synthesis of Acrylic Copolymer (a-4))

An acrylic copolymer (a-4) was obtained by the synthesis of an acrylic copolymer in the same manner as described in the synthesis of the acrylic copolymer (a-1), except that 79 parts by mass of methyl methacrylate (MMA), 15 parts by mass of N-phenylmaleimide (PhMI), and 6 parts by mass of phenoxyethyl acrylate (hereinafter sometimes referred to as “PhOEA”) were used as monomers.

(Synthesis of Acrylic Copolymer (a-5))

An acrylic copolymer (a-5) was obtained by the synthesis of an acrylic copolymer in the same manner as described in the synthesis of the acrylic copolymer (a-1), except that 82 parts by mass of methyl methacrylate (MMA), 16 parts by mass of N-phenylmaleimide (PhMI), and 2 parts by mass of phenoxyethyl acrylate (PhOEA) were used as monomers.

(Synthesis of Acrylic Copolymer (a-6))

An acrylic copolymer (a-6) was obtained by the synthesis of an acrylic copolymer in the same manner as described in the synthesis of the acrylic copolymer (a-1), except that 80 parts by mass of methyl methacrylate (MMA), 9 parts by mass of N-phenylmaleimide (PhMI), and 11 parts by mass of phenoxyethyl methacrylate (hereinafter sometimes referred to as “PhOEMA”) were used as monomers.

(Synthesis of Acrylic Copolymer (a-7))

An acrylic copolymer (a-7) was obtained by the synthesis of an acrylic copolymer in the same manner as described in the synthesis of the acrylic copolymer (a-1), except that 81 parts by mass of methyl methacrylate (MMA), 17 parts by mass of N-phenylmaleimide (PhMI), and 2 parts by mass of phenoxyethyl methacrylate (PhOEMA) were used as monomers.

(Synthesis of Acrylic Copolymer (a-8))

An acrylic copolymer (a-8) was obtained by the synthesis of an acrylic copolymer in the same manner as described in the synthesis of the acrylic copolymer (a-1), except that 83 parts by mass of methyl methacrylate (MMA), 8 parts by mass of N-phenylmaleimide (PhMI), and 9 parts by mass of benzyl methacrylate (hereinafter sometimes referred to as “BnMA”) were used as monomers.

(Synthesis of Acrylic Copolymer (a-9))

An acrylic copolymer (a-9) was obtained by the synthesis of an acrylic copolymer in the same manner as described in the synthesis of the acrylic copolymer (a-1), except that 80 parts by mass of methyl methacrylate (MMA), 18 parts by mass of N-phenylmaleimide (PhMI), and 2 parts by mass of benzyl methacrylate (BnMA) were used as monomers.

(Synthesis of Acrylic Copolymer (a-10))

An acrylic copolymer (a-10) was obtained by the synthesis of an acrylic copolymer in the same manner as described in the synthesis of the acrylic copolymer (a-1), except that 78 parts by mass of methyl methacrylate (MMA), 0.5 part by mass of N-phenylmaleimide (PhMI), and 21.5 parts by mass of N-cyclohexylmaleimide (hereinafter sometimes referred to as “CHMI”) were used as monomers.

(Synthesis of Acrylic Copolymer (a-11))

An acrylic polymer (a-11) was obtained by the synthesis of an acrylic copolymer in the same manner as described in the synthesis of the acrylic copolymer (a-1), except that 80 parts by mass of methyl methacrylate (MMA), 7 parts by mass of N-phenylmaleimide (PhMI), and 13 parts by mass of N-cyclohexylmaleimide (CHMI) were used as monomers.

(Synthesis of Acrylic Copolymer (a-12))

An acrylic copolymer (a-12) was obtained by the synthesis of an acrylic copolymer in the same manner as described in the synthesis of the acrylic copolymer (a-1), except that 81 parts by mass of methyl methacrylate (MMA), 2 parts by mass of N-phenylmaleimide (PhMI), 12 parts by mass of benzyl methacrylate (“BnMA”), and 5 parts by mass of N-cyclohexylmaleimide (CHMI) were used as monomers.

(Synthesis of Acrylic Copolymer (a-13))

An acrylic copolymer (a-13) was obtained by the synthesis of an acrylic copolymer in the same manner as described in the synthesis of the acrylic copolymer (a-1), except that 81 parts by mass of methyl methacrylate (MMA), 3 parts by mass of N-phenylmaleimide (PhMI), 12 parts by mass of benzyl methacrylate (“BnMA”), and 4 parts by mass of N-cyclohexylmaleimide (CHMI) were used as monomers.

(Synthesis of Acrylic Copolymer (a-14))

An acrylic copolymer (a-14) was obtained by the synthesis of an acrylic copolymer in the same manner as described in the synthesis of the acrylic copolymer (a-1), except that 65 parts by mass of methyl methacrylate (MMA), 16 parts by mass of N-phenylmaleimide (PhMI), and 19 parts by mass of 2,2,2-trifluoroethyl methacrylate (hereinafter sometimes referred to as “3FMA”) were used as monomers.

(Synthesis of Acrylic Copolymer (a-15))

An acrylic copolymer (a-15) was obtained by the synthesis of an acrylic copolymer in the same manner as described in the synthesis of the acrylic copolymer (a-1), except that 75 parts by mass of methyl methacrylate (MMA), 21 parts by mass of N-phenylmaleimide (PhMI), and 4 parts by mass of 2,2,2-trifluoroethyl methacrylate (3FMA) were used as monomers.

(Synthesis of Acrylic Copolymer (a-16))

An acrylic polymer (a-16) was obtained by the synthesis of an acrylic copolymer in the same manner as described in the synthesis of the acrylic copolymer (a-1), except that 80 parts by mass of methyl methacrylate (MMA), 10 parts by mass of N-phenylmaleimide (PhMI), and 10 parts by mass of 2,4,6-tribromophenyl acrylate (hereinafter sometimes referred to as “TBPhA”) were used as monomers.

(Synthesis of Acrylic Copolymer (a-17))

An acrylic copolymer (a-17) was obtained by the synthesis of an acrylic copolymer in the same manner as described in the synthesis of the acrylic copolymer (a-1), except that 75 parts by mass of methyl methacrylate (MMA), 1 part by mass of N-phenylmaleimide (PhMI), and 24 parts by mass of 2,4,6-tribromophenyl acrylate (TBPhA) were used as monomers.

(Synthesis of Acrylic Copolymer (a-18))

An acrylic copolymer (a-18) was obtained by the synthesis of an acrylic copolymer in the same manner as described in the synthesis of the acrylic copolymer (a-11), except that the amount of the chain transfer agent (1-octanethiol) was changed to 0.47 part by mass.

(Synthesis of Acrylic Copolymer (a-19))

An acrylic copolymer (a-19) was obtained by the synthesis of an acrylic copolymer in the same manner as described in the synthesis of the acrylic copolymer (a-11), except that the amount of the chain transfer agent (1-octanethiol) was changed to 0.08 part by mass.

(Synthesis of Acrylic Copolymer (a-20))

An acrylic copolymer (a-19) was obtained by the synthesis of an acrylic copolymer in the same manner as described in the synthesis of the acrylic copolymer (a-11), except that the amount of the chain transfer agent (1-octanethiol) was changed to 0.08 part by mass.

(Synthesis of Acrylic Copolymer (b-1))

An acrylic copolymer (b-1) was obtained by the synthesis of an acrylic copolymer in the same manner as described in the synthesis of the acrylic copolymer (a-1), except that 82 parts by mass of methyl methacrylate (MMA) and 18 parts by mass of N-cyclohexylmaleimide (CHMI) were used as monomers.

(Synthesis of Acrylic Copolymer (b-2))

An acrylic copolymer (b-2) was obtained by the synthesis of an acrylic copolymer in the same manner as described in the synthesis of the acrylic copolymer (a-1), except that 83 parts by mass of methyl methacrylate (MMA), 13 parts by mass of N-cyclohexylmaleimide (CHMI), and 4 parts by mass of phenoxyethyl acrylate (PhOEA) were used as monomers.

(Synthesis of Acrylic Copolymer (b-3))

An acrylic copolymer (b-3) was obtained by the synthesis of an acrylic copolymer in the same manner as described in the synthesis of the acrylic copolymer (a-1), except that 83 parts by mass of methyl methacrylate (MMA), 14 parts by mass of N-cyclohexylmaleimide (CHMI), and 3 parts by mass of phenoxyethyl methacrylate (PhOEMA) were used as monomers.

(Synthesis of Acrylic Copolymer (b-4))

An acrylic copolymer (b-4) was obtained by the synthesis of an acrylic copolymer in the same manner as described in the synthesis of the acrylic copolymer (a-1), except that 82 parts by mass of methyl methacrylate (MMA), 14 parts by mass of N-cyclohexylmaleimide (CHMI), and 4 parts by mass of benzyl methacrylate (BnMA) were used as monomers.

(Synthesis of Acrylic Copolymer (b-5))

An acrylic copolymer (b-5) was obtained by the synthesis of an acrylic copolymer in the same manner as described in the synthesis of the acrylic copolymer (a-1), except that 60 parts by mass of methyl methacrylate (MMA), 18 parts by mass of N-cyclohexylmaleimide (CHMI), 4 parts by mass of benzyl methacrylate (BnMA), and 18 parts by mass of dicyclopentanyl methacrylate (hereinafter sometimes referred to as “DCPMA”) were used as monomers.

(Synthesis of Acrylic Copolymer (b-6))

An acrylic copolymer (b-6) was obtained by the synthesis of an acrylic copolymer in the same manner as described in the synthesis of the acrylic copolymer (a-1), except that 63 parts by mass of methyl methacrylate (MMA), 5 parts by mass of N-cyclohexylmaleimide (CHMI), 16 parts by mass of benzyl methacrylate (BnMA), and 16 parts by mass of dicyclopentanyl methacrylate (DCPMA) were used as monomers.

(Synthesis of Acrylic Copolymer (b-7))

An acrylic copolymer (b-7) was obtained by the synthesis of an acrylic copolymer in the same manner as described in the synthesis of the acrylic copolymer (a-1), except that 65 parts by mass of methyl methacrylate (MMA), 19 parts by mass of N-cyclohexylmaleimide (CHMI), and 16 parts by mass of 2,2,2-trifluoroethyl methacrylate (3FMA) were used as monomers.

(Synthesis of Acrylic Copolymer (b-8))

An acrylic copolymer (b-8) was obtained by the synthesis of an acrylic copolymer in the same manner as described in the synthesis of the acrylic copolymer (a-1), except that 80 parts by mass of methyl methacrylate (MMA), 10 parts by mass of N-cyclohexylmaleimide (CHMI), and 10 parts by mass of 2,4,6-tribromophenyl acrylate (TBPhA) were used as monomers.

(Synthesis of Acrylic Copolymer (b-9))

An acrylic copolymer (b-9) was obtained by the synthesis of an acrylic copolymer in the same manner as described in the synthesis of the acrylic copolymer (a-1), except that 80 parts by mass of methyl methacrylate (MMA) and 20 parts by mass of N-cyclohexylmaleimide (CHMI) were used as monomers.

(Synthesis of Acrylic Copolymer (b-10))

An acrylic copolymer (b-10) was obtained by the synthesis of an acrylic copolymer in the same manner as described in the synthesis of the acrylic copolymer (b-2), except that the amount of the chain transfer agent (1-octanethiol) was changed to 0.06 part by mass.

For the acrylic polymers thus obtained, the weight average molecular weight (Mw), the glass transition temperature (Tg), the melt flow rate (MFR), the amount of residual monomers, and the 1 mass % reduction temperature were measured, and the results were as shown in Table 2 below.

TABLE 2

| | | Composition (parts by mass) | | | | | | | | | | Properties of resin | | | | |
|---|---|---|---|---|---|---|---|---|---|---|---|---|---|---|---|---|
| | | N-Aromatic | | | | | | | | | | | | | Amount of | 1% Mass |
| | | substituted | | Alkyl (meth)- | | | | | | | | | | MFR | residual | reduction |
| Acrylic | | maleimide | | acrylate units | | | | | | | | Mw | Tg | (g/10 | monomer | temp. |
| copolymer | | units | | having -Δn | | Third structural units | | | | | | (×10⁵) | (° C.) | min) | (wt %) | (° C.) |
| Exam- | a-1 | PhMI | 22 | MMA | 78 | — | — | — | — | — | — | 1.3 | 131 | 1.2 | 7 | 315 |
| ple | a-2 | PhMI | 20 | MMA | 80 | — | — | — | | — | — | 1.5 | 129 | 1.4 | 6.9 | 307 |
| | a-3 | PhMI | 17 | MMA | 83 | — | — | — | | — | — | 1.7 | 127 | 1.7 | 6.5 | 298 |
| | a-4 | PhMI | 15 | MMA | 79 | — | — | PhOEA | 6 | — | — | 1.4 | 122 | 8.2 | 2.6 | 303 |
| | a-5 | PhMI | 16 | MMA | 82 | — | — | PhOEA | 2 | — | — | 1.5 | 125 | 7.9 | 3.1 | 297 |
| | a-6 | PhMI | 9 | MMA | 80 | — | — | PhOEMA | 11 | — | — | 1.6 | 120 | 7.2 | 2.3 | 286 |
| | a-7 | PhMI | 17 | MMA | 81 | — | — | PhOEMA | 2 | — | — | 1.3 | 126 | 2.4 | 3.1 | 299 |
| | a-8 | PhMI | 8 | MMA | 83 | — | — | BnMA | 9 | — | — | 1.4 | 120 | 5.2 | 2.5 | 287 |
| | a-9 | PhMI | 18 | MMA | 80 | — | — | BnMA | 2 | — | — | 1.4 | 128 | 4.2 | 3.4 | 301 |
| | a-10 | PhMI | 0.5 | MMA | 78 | CHMI | 21.5 | — | — | — | — | 1.6 | 129 | 0.9 | 7.2 | 296 |
| | a-11 | PhMI | 7 | MMA | 80 | CHMI | 13 | — | — | — | — | 1.5 | 127 | 4.2 | 2.4 | 304 |
| | a-12 | PhMI | 2 | MMA | 81 | CHMI | 5 | BnMA | 12 | — | — | 1.6 | 130 | 3.1 | 2.2 | 293 |
| | a-13 | PhMI | 3 | MMA | 81 | CHMI | 4 | BnMA | 12 | — | — | 1.5 | 134 | 3.3 | 2.3 | 299 |
| | a-14 | PhMI | 16 | MMA | 65 | — | — | 3FMA | 19 | — | — | 1.4 | 120 | 8.6 | 2.8 | 292 |
| | a-15 | PhMI | 21 | MMA | 75 | — | — | 3FMA | 4 | — | — | 1.3 | 128 | 4.3 | 3.1 | 292 |
| | a-16 | PhMI | 10 | MMA | 80 | — | — | TBPhA | 10 | — | — | 1.5 | 126 | 2.8 | 2.7 | 302 |
| | a-17 | PhMI | 1 | MMA | 75 | — | — | TBPhA | 24 | — | — | 1.3 | 124 | 3.1 | 1.9 | 295 |
| | a-18 | PhMI | 7 | MMA | 80 | CHMI | 13 | — | — | — | — | 0.8 | 126 | 9.4 | 2.3 | 299 |
| | a-19 | PhMI | 7 | MMA | 80 | CHMI | 13 | — | — | — | — | 2.8 | 129 | 1.0 | 2.5 | 307 |
| Compar- | b-1 | — | — | MMA | 82 | CHMI | 18 | — | — | — | — | 1.4 | 123 | 0.6 | 6.8 | 267 |
| ative | b-2 | — | — | MMA | 83 | CHMI | 13 | PhOEA | 4 | — | — | 1.6 | 114 | 6.5 | 2.6 | 283 |
| Exam- | b-3 | — | — | MMA | 83 | CHMI | 14 | PhOEMA | 3 | — | — | 1.5 | 116 | 7.9 | 2.8 | 273 |
| ple | b-4 | — | — | MMA | 82 | CHMI | 14 | BnMA | 4 | — | — | 1.5 | 119 | 4.6 | 2.5 | 265 |
| | b-5 | — | — | MMA | 60 | CHMI | 18 | BnMA | 4 | DCPMA | 18 | 1.4 | 129 | 5.3 | 2.1 | 271 |
| | b-6 | — | — | MMA | 63 | CHMI | 5 | BnMA | 16 | DCPMA | 16 | 1.8 | 122 | 4.1 | 1.8 | 258 |
| | b-7 | — | — | MMA | 65 | CHMI | 19 | 3FMA | 16 | — | — | 1.6 | 108 | 6.3 | 2.4 | 274 |
| | b-8 | — | — | MMA | 80 | CHMI | 10 | TBPhA | 10 | — | — | 1.5 | 114 | 5.6 | 2.5 | 281 |
| | b-9 | — | — | MMA | 80 | CHMI | 20 | — | — | — | — | 1.6 | 129 | 0.5 | 7.1 | 276 |
| | b-10 | — | — | MMA | 83 | CHMI | 13 | PhOEA | 4 | — | — | 30 | 114 | 0.3 | 2.9 | 283 |

<Method for Evaluation of Optical Film>

The following optical films of Examples and Comparative Examples were produced using the acrylic copolymers prepared above. For the optical films of Examples and Comparative Examples, the thickness, the unevenness of the thickness, the in-plane phase difference, Re, the phase difference in the thicknesswise direction, Rth, the photoelastic coefficient, C, the MIT folding endurance frequency, the b* value that is a measure of yellowness, and the lightfastness were measured as follows.

The thickness of the optical film (A-1) was measured with a digital length measuring machine (Digimicro MF501, manufactured by Nikon Corporation). The unevenness of the film thickness (unit: %) was determined by cutting off an edge of both ends of a web film by 10 mm to prepare a roll sample, measuring the thickness of the film at 20 points at equal intervals in the direction of the width, and calculating the unevenness of the thickness according to the following equation: Unevenness of thickness=100×(t₁−t₂)/t₃ where is the maximum value of the thickness, μm; t₂ is the minimum value of the thickness, μm; and t₃ is the average of the thickness, μm.

The in-plane phase difference, Re, and the phase difference in the thicknesswise direction, Rth, were measured with an Axoscan apparatus manufactured by Axometrics.

The photoelastic coefficient C is determined by measuring the level of change in retardation (Re) (a phase difference) of the film caused by stress applied to the optical film with an Axoscan apparatus manufactured by Axometrics. Specifically, the photoelastic coefficient C is calculated by equation (3).

C=ΔRe/(Δσ×t) (3)

where Δσ represents the level of change in stress applied to the film, Pa; t represents the thickness of the film, m; and ΔRe represents the level of change in in-plane phase difference value corresponding to the level of change in stress indicated by Δσ, m.

The MIT folding endurance frequency was measured with a BE-201 MIT folding endurance testing machine manufactured by Tester Sangyo Co., Ltd. according to JIS P 8115. The measurement was carried out under conditions of a load of 200 g, a flexing point end R of 0.38, a flexing rate of 175 times/min, a flexing angle of 135° on right and left, and a film sample width of 15 mm. The average of the number of times of flexing that caused breaking in repeated flexing of the optical film in the conveying direction (MD direction), and the number of times of flexing that caused breaking in repeated flexing in the widthwise direction (TD direction) was regarded as the MIT folding endurance frequency.

The b* value that is a measure of yellowness was determined by measuring a spectroscopic spectrum of the optical film with Spectrophotometer SD6000 manufactured by NIPPON DENSHOKU INDUSTRIES CO., LTD. The measurement was carried out by subjecting the optical film to light irradiation with a xenon weatherometer (Atlas Ci4000 manufactured by Toyo Seiki Seisaku-Sho, Ltd.) under conditions of an irradiance of 60 W/m², a black panel temperature of 63±3° C., a humidity of 50% RH, and an irradiation time of 600 hr.

The lightfastness was evaluated by subjecting the optical film to light irradiaiton with a xenon weatherometer (Atlas Ci4000 manufactured by Toyo Seiki Seisaku-Sho, Ltd.)

under conditions of an irradiance of 60 W/m², a black panel temperature of 63±3° C., a humidity of 50% RH, and an irradiation time of 600 hr. A value obtained by subtracting b* value after light irradiation from b* value (b*¹) before light irradiation, i.e., Δb* (=b*¹−b*), a value obtained by subtracting an in-plane phase difference Re after light irradiation from a in-plane phase difference Re before light irradiation, i.e., ΔRe (=Re before light irradiation−Re after light irradiation), a value obtained by subtracting a phase difference value in the thicknesswise direction, Rth, after light irradiation from a phase difference value in the thicknesswise direction, Rth, before light irradiation, i.e., ΔRth (=Rth before light irradiation−Rth after light irradiation), a value obtained by subtracting a photoelastic coefficient C, after light irradiation from a photoelastic coefficient C before light irradiation, i.e., ΔC (=C before light irradiation−C after light irradiation), and a value obtained by subtracting a MIT folding endurance frequency after light irradiation from a MIT folding endurance frequency before light irradiation, i.e., ΔMIC (MIT before light irradiation−MIT after light irradiation), were determined for the evaluation of lightfastness.

<Production of Optical Film>

Optical films were produced using the acrylic copolymers thus obtained under film formation conditions specified in Table 3, and properties of the optical films were measured.

### Example 1

### Production of Optical Film (A-1)

The particulate copolymer (a-1) was extruded with a twin-screw extruder KZW-30MG manufactured by TECHNOVEL CORPORATION into a film. The diameter of the screw and the effective length (L/D) of the screw in the twin-screw extruder were 15 mm and 30, respectively, and a hanger coat-type T-die was installed in the extruder through an adapter. The extruding temperature Tp (° C.) was 251° C. because, in a noncrystalline polymer having a glass transition temperature of Tg (° C.), the extruding temperature is generally known to be optimally determined by formula (7).

Tp=5(Tg+70)/4 (7)

The first roll temperature in obtaining the web film was 136° C.

The web film (unstretched film) thus obtained was subjected to biaxially stretching with a biaxially stretching machine manufactured by Imoto Machinary Co., Ltd. (stretching temperature: Tg+9° C., stretching ratio: 1.5×1.5 times, simultaneous biaxially stretching) to obtain a 40 μm-thick optical film (A-1). As is also shown in Table 4, the optical film (A-1) thus obtained had satisfactory flexibility and, at the same time, when visually inspected, was free from clouding and transparent.

### Example 2

### Production of Optical Film (A-2)

The procedure of Example 1 was repeated to obtain a web film and an optical film (A-2) having a thickness of 40 μm from the web film, except that the acrylic copolymer (a-1) was changed to the acrylic copolymer (a-2) and the first roll temperature was changed as shown in Table 3 below. As is also shown in Table 4, the optical film (A-2) thus obtained had satisfactory flexibility and, at the same time, when visually inspected, was free from clouding and transparent.

### Example 3

### Production of Optical Film (A-3)

The procedure of Example 1 was repeated to obtain a web film and an optical film (A-3) having a thickness of 40 μm from the web film, except that the acrylic copolymer (a-1) was changed to the acrylic copolymer (a-3) and the first roll temperature was changed as shown in Table 3 below. As is also shown in Table 4, the optical film (A-3) thus obtained had satisfactory flexibility and, at the same time, when visually inspected, was free from clouding and transparent.

### Example 4

### Production of Optical Film (A-4)

The procedure of Example 1 was repeated to obtain a web film and an optical film (A-4) having a thickness of 40 μm from the web film, except that the acrylic copolymer (a-1) was changed to the acrylic copolymer (a-4) and the first roll temperature was changed as shown in Table 3 below. As is also shown in Table 4, the optical film (A-4) thus obtained had satisfactory flexibility and, at the same time, when visually inspected, was free from clouding and transparent.

### Example 5

### Production of Optical Film (A-5)

The procedure of Example 1 was repeated to obtain a web film and an optical film (A-5) having a thickness of 40 μm from the web film, except that the acrylic copolymer (a-1) was changed to the acrylic copolymer (a-5) and the first roll temperature was changed as shown in Table 3 below. As is also shown in Table 4, the optical film (A-5) thus obtained had satisfactory flexibility and, at the same time, when visually inspected, was free from clouding and transparent.

### Example 6

### Production of Optical Film (A-6)

The procedure of Example 1 was repeated to obtain a web film and an optical film (A-6) having a thickness of 40 μm from the web film, except that the acrylic copolymer (a-1) was changed to the acrylic copolymer (a-6) and the first roll temperature was changed as shown in Table 3 below. As is also shown in Table 4, the optical film (A-6) thus obtained had satisfactory flexibility and, at the same time, when visually inspected, was free from clouding and transparent.

### Example 7

### Production of Optical Film (A-7)

The procedure of Example 1 was repeated to obtain a web film and then an optical film (A-7) having a thickness of 40 μm from the web film, except that the acrylic copolymer (a-1) was changed to the acrylic copolymer (a-7) and the first roll temperature was changed as shown in Table 3 below. As is also shown in Table 4, the optical film (A-7) thus obtained had satisfactory flexibility and, at the same time, when visually inspected, was free from clouding and transparent.

### Example 8

### Production of Optical Film (A-8)

The procedure of Example 1 was repeated to obtain a web film and then an optical film (A-8) having a thickness of 40 μm from the web film—except that the acrylic copolymer (a-1) was changed to the acrylic copolymer (a-8) and the first roll temperature was changed as shown in Table 3 below. As is also shown in Table 4, the optical film (A-8) thus obtained had satisfactory flexibility and, at the same time, when visually inspected, was free from clouding and transparent.

### Example 9

### Production of Optical Film (A-9)

The procedure of Example 1 was repeated to obtain a web film and then an optical film (A-9) having a thickness of 40 μm from the web film, except that the acrylic copolymer (a-1) was changed to the acrylic copolymer (a-9) and the first roll temperature was changed as shown in Table 3 below. As is also shown in Table 4, the optical film (A-9) thus obtained had satisfactory flexibility and, at the same time, when visually inspected, was free from clouding and transparent.

### Example 10

### Production of Optical Film (A-10)

The procedure of Example 1 was repeated to obtain a web film and then an optical film (A-10) having a thickness of 40 μm from the web film, except that the acrylic copolymer (a-1) was changed to the acrylic copolymer (a-10) and the first roll temperature was changed as shown in Table 3 below. As is also shown in Table 4, the optical film (A-10) thus obtained had satisfactory flexibility and, at the same time, when visually inspected, was free from clouding and transparent.

### Example 11

### Production of Optical Film (A-11)

The procedure of Example 1 was repeated to obtain a web film and then an optical film (A-11) having a thickness of 40 μm from the web film, except that the acrylic copolymer (a-1) was changed to the acrylic copolymer (a-11) and the first roll temperature was changed as shown in Table 3 below. As is also shown in Table 4, the optical film (A-11) thus obtained had satisfactory flexibility and, at the same time, when visually inspected, was free from clouding and transparent.

### Example 12

### Production of Optical Film (A-12)

The procedure of Example 1 was repeated to obtain a web film and then an optical film (A-12) having a thickness of 40 μm from the web film, except that the acrylic copolymer (a-1) was changed to the acrylic copolymer (a-12) and the first roll temperature was changed as shown in Table 3 below. As is also shown in Table 4, the optical film (A-12) thus obtained had satisfactory flexibility and, at the same time, when visually inspected, was free from clouding and transparent.

### Example 13

### Production of Optical Film (A-13)

The procedure of Example 1 was repeated to obtain a web film and then an optical film (A-13) having a thickness of 40 μm from the web film, except that the acrylic copolymer (a-1) was changed to the acrylic copolymer (a-13) and the first roll temperature was changed as shown in Table 3 below. As is also shown in Table 4, the optical film (A-13) thus obtained had satisfactory flexibility and, at the same time, when visually inspected, was free from clouding and transparent.

### Example 14

### Production of Optical Film (A-14)

The procedure of Example 1 was repeated to obtain a web film and then an optical film (A-14) having a thickness of 40 μm from the web film, except that the acrylic copolymer (a-1) was changed to the acrylic copolymer (a-14) and the first roll temperature was changed as shown in Table 3 below. As is also shown in Table 4, the optical film (A-14) thus obtained had satisfactory flexibility and, at the same time, when visually inspected, was free from clouding and transparent.

### Example 15

### Production of Optical Film (A-15)

The procedure of Example 1 was repeated to obtain a web film and then an optical film (A-15) having a thickness of 40 μm from the web film, except that the acrylic copolymer (a-1) was changed to the acrylic copolymer (a-15) and the first roll temperature was changed as shown in Table 3 below. As is also shown in Table 4, the optical film (A-15) thus obtained had satisfactory flexibility and, at the same time, when visually inspected, was free from clouding and transparent.

### Example 16

### Production of Optical Film (A-16)

The procedure of Example 1 was repeated to obtain a web film and then an optical film (A-16) having a thickness of 40 μm from the web film, except that the acrylic copolymer (a-1) was changed to the acrylic copolymer (a-16) and the first roll temperature was changed as shown in Table 3 below. As is also shown in Table 4, the optical film (A-16) thus obtained had satisfactory flexibility and, at the same time, when visually inspected, was free from clouding and transparent.

### Example 17

### Production of Optical Film (A-17)

The procedure of Example 1 was repeated to obtain a web film and then an optical film (A-17) having a thickness of 40 μm from the web film, except that the acrylic copolymer (a-1) was changed to the acrylic copolymer (a-17) and the first roll temperature was changed as shown in Table 3 below. As is also shown in Table 4, the optical film (A-17) thus obtained had satisfactory flexibility and, at the same time, when visually inspected, was free from clouding and transparent.

### Example 18

### Production of Optical Film (A-18)

The procedure of Example 1 was repeated to obtain an unstretched film, except that the acrylic copolymer (a-1) was changed to the acrylic copolymer (a-18) and the first roll temperature was changed as shown in Table 3 below. The web film (unstretched film) thus obtained was subjected to single-screw stretching with a biaxially stretching machine manufactured by Imoto Machinery Co., Ltd. (stretching temperature: Tg+9° C., stretching ratio: 1.5×1.0 times, to obtain a web film and then a 40 μm-thick optical film (A-18) from the web film. As is also shown in Table 4, the optical film (A-18) thus obtained had satisfactory flexibility and, at the same time, when visually inspected, was free from clouding and transparent.

### Example 19

### Production of Optical Film (A-19)

The procedure of Example 1 was repeated to obtain a web film and then an optical film (A-19) having a thickness of 40 μm from the web film, except that the acrylic copolymer (a-1) was changed to the acrylic copolymer (a-19), the stretch ratio was changed to 2.0×2.0 times and the first roll temperature was changed as shown in Table 3 below. As is also shown in Table 4, the optical film (A-19) thus obtained had satisfactory flexibility and, at the same time, when visually inspected, was free from clouding and transparent.

### Example 20

### Production of Optical Film (A-20)

The procedure of Example 11 was repeated to obtain a web film and then an optical film (A-20) having a thickness of 40 μm from the web film, except that, as shown in Table 3, the stretching ratio was changed to 1.5×1.0 times. As is also shown in Table 4, the optical film (A-20) thus obtained had satisfactory flexibility and, at the same time, when visually inspected, was free from clouding and transparent.

### Example 21

### Production of Optical Film (A-21)

The procedure of Example 11 was repeated to obtain a web film and then an optical film (A-21) having a thickness of 40 μm from the web film, except that, as shown in Table 3, the stretching ratio was changed to 2.0×2.0 times. As is also shown in Table 4, the optical film (A-21) thus obtained had satisfactory flexibility and, at the same time, when visually inspected, was free from clouding and transparent.

### Example 22

### Production of Optical Film (A-22)

The procedure of Example 11 was repeated to obtain a web film and then an optical film (A-22) having a thickness of 40 μm from the web film, except that, as shown in Table 3, the first roll temperature was changed to 147° C. As is also shown in Table 4, the optical film (A-22) thus obtained had satisfactory flexibility and, at the same time, when visually inspected, was free from clouding and transparent.

### Example 23

### Production of Optical Film (A-23)

The procedure of Example 20 was repeated to obtain a web film and then an optical film (A-23) having a thickness of 40 μm from the web film, except that, as shown in Table 3, the first roll temperature was changed to 107° C. As is also shown in Table 4, the optical film (A-23) thus obtained had satisfactory flexibility and, at the same time, when visually inspected, was free from clouding and transparent.

### Comparative Example 1

### Production of Optical Film (B-1)

The procedure of Example 1 was repeated to obtain a web film and then an optical film (B-1) having a thickness of 40 μm from the web film, except that the acrylic copolymer (a-1) was changed to an acrylic copolymer (b-1) and the first roll temperature was changed as specified in Table 5. As shown in Table 6, the optical film (A-4) thus obtained had low pyrolysis temperature and thus had a problem of heat resistance.

### Comparative Example 2

### Production of Optical Film (B-2)

The procedure of Example 1 was repeated to obtain a web film and then an optical film (B-2) having a thickness of 40 μm from the web film, except that the acrylic copolymer (a-1) was changed to an acrylic copolymer (b-2) and the first roll temperature was changed as specified in Table 5. As shown in Table 6, the optical film (A-4) thus obtained had low glass transition temperature and thus had a problem of heat resistance.

### Comparative Example 3

### Production of Optical Film (B-3)

The procedure of Example 1 was repeated to obtain a web film and then an optical film (B-3) having a thickness of 40 μm from the web film, except that the acrylic copolymer (a-1) was changed to an acrylic copolymer (b-3) and the first roll temperature was changed as specified in Table 5. As shown in Table 6, the optical film (A-4) thus obtained had low pyrolysis temperature and glass transition temperature and thus had a problem of heat resistance.

### Comparative Example 4

### Production of Optical Film (B-4)

The procedure of Example 1 was repeated to obtain a web film and then an optical film (B-4) having a thickness of 40 μm from the web film, except that the acrylic copolymer (a-1) was changed to an acrylic copolymer (b-4) and the first roll temperature was changed as specified in Table 5. As shown in Table 6, the optical film (A-4) thus obtained had low pyrolysis temperature and glass transition temperature and thus had a problem of heat resistance.

### Comparative Example 5

### Production of Optical Film (B-5)

The procedure of Example 1 was repeated to obtain a web film and then an optical film (B-5) having a thickness of 40 μm from the web film, except that the acrylic copolymer (a-1) was changed to an acrylic copolymer (b-5) and the first roll temperature was changed as specified in Table 5. As shown in Table 6, the optical film (A-4) thus obtained had low pyrolysis temperature and thus had a problem of heat resistance.

### Comparative Example 6

### Production of Optical Film (B-6)

The procedure of Example 1 was repeated to obtain a web film and then an optical film (B-6) having a thickness of 40 μm from the web film, except that the acrylic copolymer (a-1) was changed to an acrylic copolymer (b-6) and the first roll temperature was changed as specified in Table 5. As shown in Table 6, the optical film (A-4) thus obtained had low pyrolysis temperature and thus had a problem of heat resistance.

### Comparative Example 7

### Production of Optical Film (B-7)

The procedure of Example 1 was repeated to obtain a web film and then an optical film (B-7) having a thickness of 40 μm from the web film, except that the acrylic copolymer (a-1) was changed to an acrylic copolymer (b-7) and the first roll temperature was changed as specified in Table 5. As shown in Table 6, the optical film (A-4) thus obtained had low pyrolysis temperature and glass transition temperature and thus had a problem of heat resistance.

### Comparative Example 8

### Production of Optical Film (B-8)

The procedure of Example 1 was repeated to obtain a web film and then an optical film (B-8) having a thickness of 40 μm from the web film, except that the acrylic copolymer (a-1) was changed to an acrylic copolymer (b-8) and the first roll temperature was changed as specified in Table 5. As shown in Table 6, the optical film (A-4) thus obtained had low glass transition temperature and thus had a problem of heat resistance.

### Comparative Example 9

### Production of Optical Film (B-9)

The procedure of Example 1 was repeated to obtain a web film and then an optical film (B-9) having a thickness of 40 μm from the web film, except that the acrylic copolymer (a-1) was changed to an acrylic copolymer (b-9) and the first roll temperature was changed as specified in Table 5. As shown in Table 6, the optical film (A-4) thus obtained had low pyrolysis temperature and thus had a problem of heat resistance.

### Comparative Example 10

### Production of Optical Film (B-10)

An attempt was made to produce an optical film in the same manner as in Comparative Example 9, except that the first roll temperature was changed to 154° C. as specified in Table 5 below. However, the optical film could not be formed due to sticking of the web film to the first roll.

### Comparative Example 11

### Production of Optical Film (B-11)

The procedure of Comparative Example 9 was repeated to obtain a web film and then an optical film (B-10) having a thickness of 40 μm from the web film, except that the first roll temperature was changed to 104° C. as specified in Table 5. As shown in Table 6, the optical film (B-10) thus obtained had low pyrolysis temperature and thus had a problem of heat resistance.

### Comparative Example 12

### Production of Optical Film (B-12)

The procedure of Comparative Example 2 was repeated to obtain a web film and then an optical film (B-12) having a thickness of 40 μm from the web film, except that the acrylic copolymer (b-2) was changed to an acrylic copolymer (b-10). As shown in Table 6, in the optical film (B-12), the acrylic copolymer had a high weight average molecular weight, and a difference in pressure between before a filter and after the filter in the twin-screw extruder was large. Thus, the acrylic copolymer was unsuitable for film formation.

For the optical films of Examples and Comparative Examples thus obtained, the unevenness of the thickness, the in-plane phase difference, Re, the phase difference in the thicknesswise direction, Rth, the photoelastic coefficient, C, the MIT folding endurance frequency, the b* value that is a measure of yellowness, and the lightfastness were measured. The results were as shown in Tables 4 and 6.

TABLE 3

| | | Conditions for film formation | | | | |
|---|---|---|---|---|---|---|
| | | Difference in pressure | First | Unevenness | Stretch ratio | |
| | | between before and | roll | of film | | Area |
| Optical film | Acrylic | behind polymer filter | temp. | thickness | Stretch | ratio |
| (Example) | copolymer | (MPa) | T1(° C.) | (%) | ratio | (times) |
| A-1 | a-1 | 9.8 | 136 | 5 | 9.8 | 136 |
| A-2 | a-2 | 9.7 | 134 | 5 | 9.7 | 134 |
| A-3 | a-3 | 9.5 | 132 | 5 | 9.5 | 132 |
| A-4 | a-4 | 5 | 127 | 5 | 5 | 127 |
| A-5 | a-5 | 5.4 | 130 | 5 | 5.4 | 130 |
| A-6 | a-6 | 5.6 | 125 | 5 | 5.6 | 125 |
| A-7 | a-7 | 8.8 | 131 | 5 | 8.8 | 131 |
| A-8 | a-8 | 6.8 | 125 | 5 | 6.8 | 125 |
| A-9 | a-9 | 7.3 | 133 | 5 | 7.3 | 133 |
| A-10 | a-10 | 9.9 | 134 | 5 | 9.9 | 134 |
| A-11 | a-11 | 7.3 | 132 | 5 | 7.3 | 132 |
| A-12 | a-12 | 8.2 | 135 | 5 | 8.2 | 135 |
| A-13 | a-13 | 7.9 | 139 | 5 | 7.9 | 139 |
| A-14 | a-14 | 4.9 | 125 | 5 | 4.9 | 125 |
| A-15 | a-15 | 7.4 | 133 | 5 | 7.4 | 133 |
| A-16 | a-16 | 8.7 | 131 | 5 | 8.7 | 131 |
| A-17 | a-17 | 8.2 | 129 | 5 | 8.2 | 129 |
| A18 | a-18 | 4.6 | 131 | 5 | 4.6 | 131 |
| A-19 | a-19 | 9.9 | 134 | 5 | 9.9 | 134 |
| A-20 | a-11 | 7.3 | 132 | 5 | 7.3 | 132 |
| A-21 | | 7.3 | 132 | 5 | 7.3 | 132 |
| A-22 | | 7.3 | 147 | 5 | 7.3 | 147 |
| A-23 | | 7.3 | 107 | 5 | 7.3 | 107 |

TABLE 4

| | | Properties of optical film | | | | | | | | | |
|---|---|---|---|---|---|---|---|---|---|---|---|
| | | | Phase | | MIT | | | | | | |
| | | In-plane | difference in | | folding | | | | | | |
| | Acrylic | phase | thicknesswise | Photoelastic | endurance | | Lightfastness | | | | |
| Optical film | co- | difference | direction | coefficient | frequency | b* | | ΔRe | ΔRth | ΔC | ΔMIT |
| (Example) | polymer | Re (nm) | Rth(nm) | C(×10⁻¹²/Pa) | (times) | value | Δb* | (nm) | (nm) | (×10⁻¹²/Pa) | (times) |
| A-1 | a-1 | 1.3 | 2.7 | 2.8 | 184 | 0.72 | 0.34 | 0.2 | 0.3 | 0.1 | 74 |
| A-2 | a-2 | 0.1 | 0.2 | 2.2 | 171 | 0.65 | 0.31 | 0.1 | 0.3 | −0.3 | 65 |
| A-3 | a-3 | −1.6 | −3.0 | 1.2 | 163 | 0.61 | 0.29 | −0.1 | −0.3 | −0.4 | 63 |
| A-4 | a-4 | 1.8 | 2.9 | 3 | 162 | 0.57 | 0.01 | −0.1 | 0.2 | 0 | 16 |
| A-5 | a-5 | −0.4 | −0.7 | 1.9 | 168 | 0.54 | 0.02 | −0.2 | 0.1 | 0.1 | 21 |
| A-6 | a-6 | 1.9 | 2.9 | 3 | 151 | 0.43 | 0.01 | −0.1 | 0.2 | 0.1 | 18 |
| A-7 | a-7 | −0.1 | −0.2 | 0.9 | 178 | 0.37 | 0.02 | −0.2 | −0.3 | −0.2 | 24 |
| A-8 | a-8 | −1.2 | −2.3 | 2.9 | 156 | 0.39 | 0.01 | −0.3 | −0.4 | 0.1 | 15 |
| A-9 | a-9 | 0.2 | 0.4 | 2.7 | 185 | 0.51 | 0.03 | 0.1 | 0.2 | 0.2 | 28 |
| A-10 | a-10 | 1.9 | 2.8 | −1 | 226 | 0.33 | 0.19 | 0.3 | 0.5 | −0.1 | 69 |
| A-11 | a-11 | −0.2 | −0.4 | −0.1 | 211 | 0.21 | 0.01 | 0.1 | 0.1 | 0.2 | 28 |
| A-12 | a-12 | 0 | 0.1 | 0.1 | 171 | 0.29 | 0.01 | 0.1 | 0.2 | −0.3 | 20 |
| A-13 | a-13 | −0.5 | −1.2 | 0 | 178 | 0.28 | 0.01 | 0 | 0.1 | −0.1 | 22 |
| A-14 | a-14 | −0.2 | −0.4 | 0.6 | 167 | 0.34 | 0.01 | 0.2 | 0.3 | −0.3 | 24 |
| A-15 | a-15 | 1.5 | 2.9 | 2.9 | 187 | 0.42 | 0.02 | −0.1 | −0.2 | 0.1 | 31 |
| A-16 | a-16 | −0.2 | −0.3 | 0.3 | 295 | 0.36 | 0.01 | 0 | 0.1 | −0.3 | 28 |
| A-17 | a-17 | 2.1 | 2.9 | −1.5 | 188 | 0.18 | 0.01 | −0.1 | −0.3 | −0.4 | 29 |
| A18 | a-18 | −0.2 | −0.4 | −0.1 | 189 | 0.21 | 0.01 | 0.1 | 0.1 | 0.2 | 36 |
| A-19 | a-19 | −0.2 | −0.4 | −0.1 | 250 | 0.21 | 0.01 | 0.1 | 0.1 | 0.2 | 12 |
| A-20 | a-11 | −0.2 | −0.4 | −0.1 | 200 | 0.21 | 0.01 | 0.1 | 0.1 | 0.2 | 28 |
| A-21 | | −0.2 | −0.4 | −0.1 | 233 | 0.21 | 0.01 | 0.1 | 0.1 | 0.2 | 22 |
| A-22 | | −0.2 | −0.4 | −0.1 | 211 | 0.21 | 0.01 | 0.1 | 0.1 | 0.2 | 28 |
| A-23 | | −0.2 | −0.4 | −0.1 | 211 | 0.21 | 0.01 | 0.1 | 0.1 | 0.2 | 28 |

TABLE 5

| | | Conditions for film formation | | | | |
|---|---|---|---|---|---|---|
| | | Difference in pressure | First | Unevenness | Stretch ratio | |
| Optical film | Acrylic | between before and | roll | of film | | Area |
| (Comparative | co- | behind polymer filter | temp. | thickness | Stretch | ratio |
| Example) | polymer | (MPa) | T1(° C.) | (%) | ratio | (times) |
| B-1 | b-1 | 11.3 | 128 | 5 | 1.5 × 1.5 | 2.25 |
| B-2 | b-2 | 6 | 119 | 5 | 1.5 × 1.5 | 2.25 |
| B-3 | b-3 | 5 | 121 | 5 | 1.5 × 1.5 | 2.25 |
| B-4 | b-4 | 7.3 | 124 | 5 | 1.5 × 1.5 | 2.25 |
| B-5 | b-5 | 6.9 | 134 | 5 | 1.5 × 1.5 | 2.25 |
| B-6 | b-6 | 7.5 | 127 | 5 | 1.5 × 1.5 | 2.25 |
| B-7 | b-7 | 5.9 | 113 | 5 | 1.5 × 1.5 | 2.25 |
| B-8 | b-8 | 6.6 | 119 | 5 | 1.5 × 1.5 | 2.25 |
| B-9 | b-9 | 12.5 | 134 | 5 | 1.5 × 1.5 | 2.25 |
| B-10 | | 12.5 | 154 | Impossible to form film due to | | |
| | | | | sticking of film to first roll | | |
| B-11 | | 12.5 | 104 | 10 | 1.5 × 1.5 | 2.25 |
| B-12 | b-10 | 14.8 | 119 | 10 | 1.5 × 1.5 | 2.25 |

TABLE 6

| | | Properties of optical film | | | | | | | | | |
|---|---|---|---|---|---|---|---|---|---|---|---|
| Optical | | | Phase | | MIT | | | | | | |
| film | | In-plane | difference in | | folding | | | | | | |
| (Compar- | Acrylic | phase | thicknesswise | Photoelastic | endurance | | Lightfastness | | | | |
| ative | co- | difference | direction | coefficient | frequency | b* | | ΔRe | ΔRth | ΔC | ΔMIT |
| Example) | polymer | Re (nm) | Rth (nm) | C(×10¹²/Pa) | (times) | value | Δb* | (nm) | (nm) | (×10−¹²/Pa) | (times) |
| B-1 | b-1 | −0.3 | −0.5 | −1.6 | 164 | 0.29 | 0.18 | −0.1 | 0.2 | −0.2 | 19 |
| B-2 | b-2 | 0.5 | 0.9 | −2 | 157 | 0.29 | 0.02 | 0.1 | 0.2 | −0.3 | 25 |
| B-3 | b-3 | −0.4 | −0.7 | −0.9 | 168 | 0.28 | 0.02 | −0.2 | −0.3 | −0.1 | 33 |
| B-4 | b-4 | −0.3 | −0.5 | 0 | 173 | 0.28 | 0.01 | −0.1 | −0.2 | 0 | 26 |
| B-5 | b-5 | 1.2 | 2.2 | 2.6 | 68 | 0.23 | 0.01 | 0.5 | 0.8 | −0.5 | 19 |
| B-6 | b-6 | 1.3 | 2.3 | 6.7 | 25 | 0.25 | 0.01 | −0.6 | −0.9 | −0.7 | 13 |
| B-7 | b-7 | 2.1 | 4.3 | −1.3 | 51 | 0.26 | 0.01 | −0.9 | −1.7 | −1.1 | 21 |
| B-8 | b-8 | −0.1 | −0.3 | −1.7 | 114 | 0.24 | 0.01 | 0.2 | 0.3 | 0.6 | 22 |
| B-9 | b-9 | −0.6 | −1.3 | −1.6 | 220 | 0.31 | 0.25 | 2.1 | 4.4 | −1.3 | 85 |
| B-10 | | Impossible to form film due to sticking of film to first roll | | | | | | | | | |
| B-11 | | −0.6 | −1.3 | −1.6 | 220 | 0.31 | 0.25 | 2.1 | 4.4 | −1.3 | 94 |
| B-12 | b-10 | 0.5 | 0.9 | −2 | 157 | 0.29 | 0.02 | 0.1 | 0.2 | −0.3 | 43 |

1. An acrylic copolymer comprising as constituent units 0.5 to 35% by mass of N-aromatic substituted maleimide units and 60 to 85% by mass of alkyl (meth)acrylate units having a negative intrinsic birefringence in terms of a homopolymer.

2. The acrylic copolymer according to claim 1, which further comprises third constituent units selected from the group consisting of N-alkyl substituted maleimide units and (meth)acrylic ester units having a positive intrinsic birefringence in terms of a homopolymer.

3. The acrylic copolymer according to claim 2, wherein the content of the third constituent units is 1 to 24% by mass.

4. The acrylic copolymer according to any one of claims 1 to 3, wherein the N-aromatic substituted maleimide units include N-phenylmaleimide units.

5-11. (canceled)

12. An optical film produced by biaxially stretching an unstretched film of a resin material containing an acrylic copolymer according to any one of claims 1-3.

13-15. (canceled)

16. A polarizing plate comprising an optical film according to claim 12.

17. A liquid crystal display device comprising a polarizing plate according to claim 16.
